(19) United States
(12) Patent Application Publication
(10) Pub. No.: US 2009/0085359 A1
(43) Pub. Date: Apr. 2, 2009

(54) ELECTRONIC APPARATUS

(75) Inventors: Katsuji Mabuchi, Gifu-shi (JP); Hitoshi Hirano, Nishinomiya-shi (JP); Naoteru Matsubara, Ichinomiya-shi (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/239,456

(22) Filed: Sep. 26, 2008

(30) Foreign Application Priority Data
Sep. 27, 2007 (JP) 2007-250452

(51) Int. Cl. H02K 7/18; H02K 35/02

(52) U.S. Cl. 290/1 R; 310/15

(57) ABSTRACT

An electronic apparatus includes a power generator including a movable portion displaced by kinetic energy acting on an electronic apparatus body and a conversion portion converting displacement of the movable portion to electric energy, wherein the movable portion of the power generator is arranged on or below a gravity center of the electronic apparatus body in a state where the electronic apparatus body is supported in a used state.

### CROSS-REFERENCE TO RELATED APPLICATIONS

The priority application number JP2007-250452, Electronic Apparatus, Sep. 27, 2007, Katsuji Mabuchi, Hitoshi Hirano, Naoteru Matsubara, upon which this patent application is based is hereby incorporated by reference.

### BACKGROUND OF THE INVENTION

1. Field of the Invention

The present invention relates to an electronic apparatus, and more particularly, it relates to an electronic apparatus comprising a power generator converting kinetic energy acting on an electronic apparatus body to electric power.

2. Description of the Background Art

An electronic apparatus comprising a power generator converting kinetic energy acting on an electronic apparatus to electric power is known in general.

A conventional electronic apparatus comprises a power generator including a permanent magnet stored in a cylindrical container in a vibratory manner and a coil wound around the container. In this conventional electronic apparatus, the permanent magnet vibrates following displacement of the electronic apparatus. Thus, electric power can be generated in the coil wound around the container by electromagnetic induction.

### SUMMARY OF THE INVENTION

An electronic apparatus of the present invention comprises a power generator including a movable portion displaced by kinetic energy acting on an electronic apparatus body and a conversion portion converting displacement of the movable portion to electric energy, wherein the movable portion of the power generator is arranged on or below a gravity center of the electronic apparatus body in a state where the electronic apparatus body is supported in a used state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front elevational view showing an electronic apparatus according to a first embodiment of the present invention;

FIG. 2 is a side elevational view showing the electronic apparatus according to the first embodiment of the present invention;

FIG. 3 is a side elevational view (partial sectional view) showing a power generator of the electronic apparatus according to the first embodiment of the present invention;

FIG. 4 is a sectional view taken along the line 200-200 in FIG. 3;

FIGS. 5 and 6 are diagrams for illustrating the measurement results obtained by measuring change of acceleration in human walking;

FIGS. 7 to 9 are diagrams showing the measurement results obtained by measuring change of acceleration in human walking;

FIG. 10 is a sectional view showing a power generator of an electronic apparatus according to a second embodiment of the prevent invention;

FIG. 11 is a plan view showing the power generator of the electronic apparatus according to the second embodiment of the prevent invention;

FIG. 12 is a front elevational view showing an electronic apparatus according to a first modification of the first embodiment of the present invention;

FIG. 13 is a side elevational view showing the electronic apparatus according to the first modification of the first embodiment of the present invention;

FIG. 14 is a front elevational view showing an electronic apparatus according to a second modification of the first embodiment of the present invention;

FIG. 15 is a side elevational view showing the electronic apparatus according to the second modification of the first embodiment of the present invention;

FIG. 16 is a front elevational view showing an electronic apparatus according to a third modification of the first embodiment of the present invention;

FIG. 17 is a front elevational view showing an electronic apparatus according to a fourth modification of the first embodiment of the present invention;

FIG. 18 is a front elevational view showing an electronic apparatus according to a fifth modification of the first embodiment of the present invention;

FIG. 19 is a side elevational view showing the electronic apparatus according to the fifth modification of the first embodiment of the present invention;

FIG. 20 is a front elevational view showing an electronic apparatus according to a sixth modification of the first embodiment of the present invention; and

FIG. 21 is a side elevational view showing the electronic apparatus according to the sixth modification of the first embodiment of the present invention;

### DESCRIPTION OF THE PREFERRED EMBODIMENTS

Embodiments of the present invention will be hereinafter described with reference to the drawings.

### First Embodiment

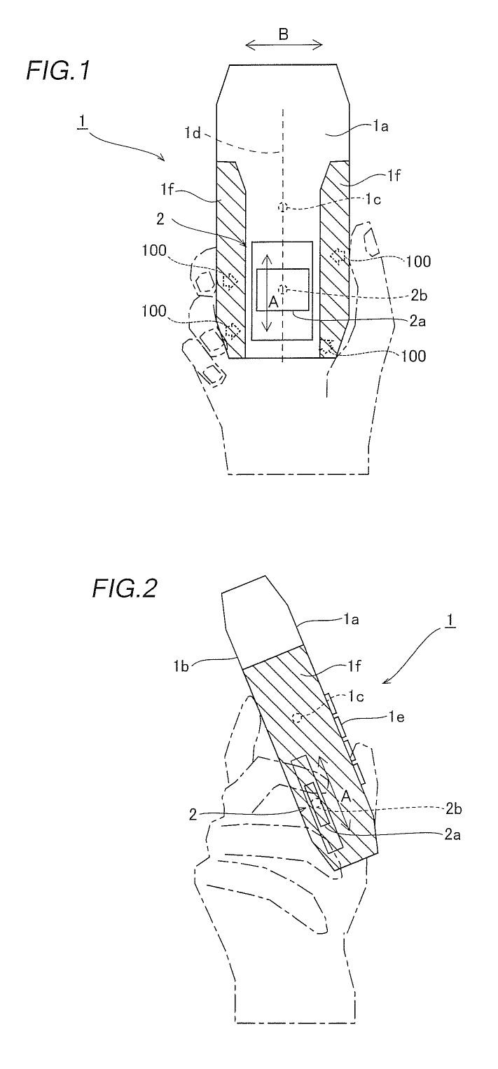

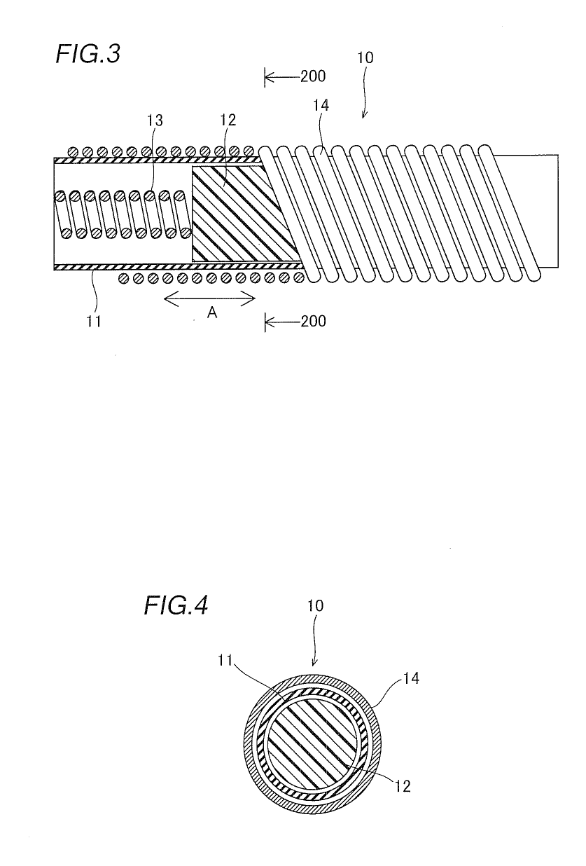

As shown in FIGS. 1 and 2, an electronic apparatus 1 is an electronic apparatus having a vertically long shape such as a portable telephone or a remote control. This electronic apparatus 1 comprises a power generator 2 for supplying electric power to an electronic component (not shown) of the electronic apparatus 1. The power generator 2 includes a movable portion 2a vibrating in a vertical direction (along arrow A) of the electronic apparatus 1 following displacement of the electronic apparatus 1 in a state where the electronic apparatus 1 is supported by a user in a used state and a conversion portion converting kinetic energy by vibration of the movable portion 2a to electric energy. Specific structures of the movable portion 2a of the power generator 2 and the conversion portion will be described in detail later. The electronic apparatus 1 includes a front surface portion 1a provided with buttons 1e (see FIG. 2) for operation by the user, a display portion (not shown) and the like and a rear surface portion 1b (see FIG. 2). In the electronic apparatus 1 in the used state, as shown in FIGS. 1 and 2, a portion (support portions 100) below a gravity center 1c of the electronic apparatus 1 is generally supported by a hand of the user. The electronic apparatus 1 in the used state is generally supported from a side of the rear surface portion 1b of the electronic apparatus 1 by the hand of the user. Nonslip structures 1f (see FIG. 1) having prescribed shaped dents are provided on regions including portions (support portions 100) grasped by the hand of the user of a part of the front surface portion 1a and a part of each side surface in the surface of the electronic apparatus 1. In side view of FIG. 2, the electronic apparatus 1 is inclined by a prescribed angle with respect to a vertical direction. This prescribed angle is preferably in the range of 45 degrees with respect to the vertical direction in view of power generation efficiency. The electronic apparatus 1 is most preferably arranged in the vertical direction in view of the power generation efficiency.

According to the first embodiment, the movable portion 2a of the power generator 2 is arranged on a portion corresponding to the portions (support portions 100) grasped by the hand of the user below the gravity center 1c of the electronic apparatus 1. As shown in FIG. 2, the movable portion 2a of the power generator 2 is arranged on the side of the rear surface portion 1b of the electronic apparatus 1. According to the first embodiment, in the used state of the electronic apparatus 1, a vibration center 2b of the movable portion 2a is arranged on a centerline 1d passing the gravity center 1c of the electronic apparatus 1 as viewed from a side of the front surface portion 1a. The centerline 1d extends in the vertical direction (along arrow A) of the electronic apparatus 1 in a state where the electronic apparatus 1 is supported in the used state. The movable portion 2a is so arranged as to move (vibrate) in a direction along a surface of the rear surface portion 1b of the electronic apparatus 1 (along arrow A).

As shown in FIGS. 3 and 4, a power generator 10 includes a cylindrical housing 11, a permanent magnet 12 stored in the housing 11, a spring 13 for vibrating the permanent magnet 12 along arrow A, a coil 14 wound around housing 11. The permanent magnet 12 is an example of the “movable portion” in the present invention. The coil 14 is an example of the “fixed portion” in the present invention. In the power generator 10, the permanent magnet 12 vibrates in the housing 11, thereby allowing generation of a current in the coil 14 due to electromagnetic induction. In the power generator 10, the permanent magnet 12 vibrates following displacement of the electronic apparatus 1 (see FIG. 1) and hence power is generated following the displacement of the electronic apparatus 1. The permanent magnet 12 and the coil 14 are each an example of the “conversion portion” in the present invention.

According to the first embodiment, as hereinabove described, the movable portion 2a of the power generator 2 is arranged below the gravity center 1c of the electronic apparatus 1 in the state where the electronic apparatus 1 is supported in the used state, whereby the movable portion 2a can be vibrated in the vicinity of the portions (support portions 100) generally supported by the hand of the user in the electronic apparatus 1. Thus, the distance between each support portion 100 and the movable portion 2a can be reduced and hence moment employing the support portions 100 as supporting points following vibration of the movable portion 2a can be reduced dissimilarly to the case where the movable portion 2a of the power generator 2 is arranged above the gravity center 1c. Thus, the power generator 2 can generate power while suppressing destabilization of the attitude of the electronic apparatus 1 when the portion below the gravity center 1c of the electronic apparatus 1 is supported.

According to the first embodiment, as hereinabove described, the movable portion 2a is arranged on the side of the rear surface portion 1b of the electronic apparatus 1, whereby the movable portion 2a can be vibrated on the side of the rear surface portion 1b generally supported by the hand of the user in the electronic apparatus 1. Thus, the distance between each support portion 100 and the movable portion 2a vibrating can be reduced and hence moment employing the rear surface portion 1b as a supporting point following the vibration of the movable portion 2a can be reduced dissimilarly to the case where the movable portion 2a of the power generator 2 is arranged on the side of the front surface portion 1a. Thus, the power generator 2 can generate power while suppressing destabilization of the attitude of the electronic apparatus 1 when the electronic apparatus 1 is supported from the side of the rear surface portion 1b.

According to the first embodiment, as hereinabove described, each of the nonslip structures 1f is provided on a part of the front surface portion 1a and a part of the side surface in the surface of the electronic apparatus 1 and the movable portion 2a is arranged on a portion corresponding to the regions provided with the nonslip structures 1f, whereby the power generator 2 can generate power while suppressing destabilization of the attitude of the electronic apparatus 1 also by the nonslip structures 1f when the user grasps the regions provided with the nonslip structures 1f.

According to the first embodiment, as hereinabove described, the movable portion 2a is arranged on a lower portion of the electronic apparatus 1 in the state of supporting a portion below the gravity center 1c of the electronic apparatus 1, whereby the movable portion 2a can be vibrated in the vicinity of the portions (support portions 100) generally supported and hence the power generator 2 can generate power while suppressing destabilization of the attitude of the electronic apparatus 1.

According to the first embodiment, as hereinabove described, the movable portion 2a is so formed as to generate power by displacement due to kinetic energy acting on the electronic apparatus 1 resulting from movement of the user, whereby power can be generated by just the movement of the user.

According to the first embodiment, as hereinabove described, the movable portion 2a is so formed as to move (vibrate) in the direction (along arrow A) along the surface of the rear surface portion 1b of the electronic apparatus 1, whereby the inertial force by the vibration of the movable portion 2a can be inhibited from acting in a direction (along arrow B) perpendicular to the direction (along arrow A) along the surface of the rear surface portion 1b and hence the electronic apparatus 1 can generate power while inhibiting the electronic apparatus 1 from shaking along arrow B.

According to the first embodiment, as hereinabove described, the movable portion 2a vibrates on the centerline 1d extending in the vertical direction passing the gravity center 1c of the electronic apparatus 1 as viewed from the side of the front surface portion 1a along the direction (along arrow A) along the surface of the rear surface portion 1b of the electronic apparatus 1, whereby the inertial force by the vibration of the movable portion 2a can be inhibited from acting in the direction (along arrow B) perpendicular to the centerline 1d and hence the electronic apparatus 1 can generate power while inhibiting the electronic apparatus 1 from shaking along arrow B.

According to the first embodiment, as hereinabove described, the vibration center 2b of the movable portion 2a is arranged on the centerline 1d passing the gravity center 1c of the electronic apparatus 1 in the state where the electronic apparatus 1 is supported in the used state, whereby the inertial force by the vibration of the movable portion 2a can inhibit force from acting in the direction (along arrow B) perpendicular to the centerline 1d of the electronic apparatus 1 dissimilarly to the case where the vibration center 2b of the movable portion 2a is not on the centerline 1d passing the gravity center 1c and hence the power generator 2 can generate power while suppressing destabilization of the attitude of the electronic apparatus 1.

According to the first embodiment, as hereinabove described, the movable portion 2a is so arranged as to vibrate on the centerline 1d extending the vertical direction of the electronic apparatus 1 in the state where the portion below the gravity center 1c of the electronic apparatus 1 is supported, whereby the inertial force by the vibration of the movable portion 2a can inhibit force from acting in the direction (along arrow B) perpendicular to the centerline 1d dissimilar to the case where the movable portion 2a does not vibrate on the centerline 1d, and hence the power generator 2 can generate power while suppressing destabilization of the attitude of the electronic apparatus 1.

According to the first embodiment, as hereinabove described, kinetic energy acting on the electronic apparatus 1 can be converted to electric energy by relative movement of the movable portion 2a to the fixed portion, thereby easily allowing power generation by utilizing the kinetic energy.

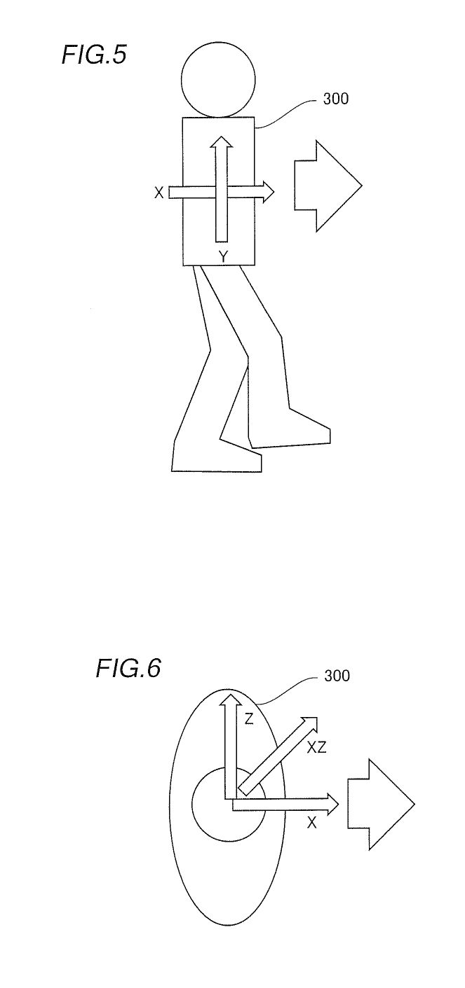

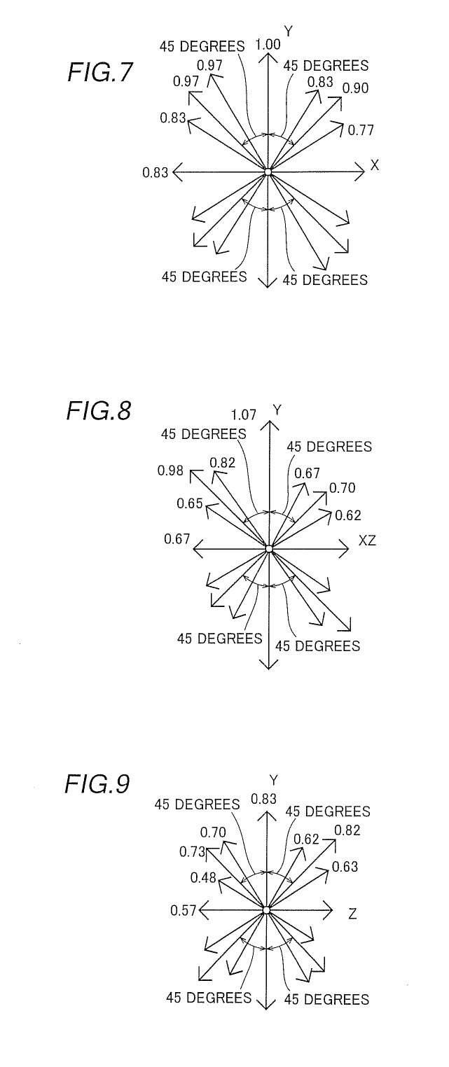

As shown in FIGS. 5 and 6, assuming that a direction X represents a traveling direction, a direction Y represents a vertical direction, a lateral direction opening with respect to the traveling direction (direction X) by 90 degrees represents a direction Z and a direction XZ represents an oblique lateral direction opening with respect to the traveling direction by 45 degrees, change of acceleration in each direction in a case where a human 300 walks at a speed of 4 kilometers per hour was measured. FIGS. 7, 8 and 9 show the results the change of the acceleration in an X-Y plane, the change of the acceleration in an XZ-Y plane, and the change of the acceleration in a Z-Y plane, respectively.

As shown in FIGS. 7 to 9, it has been proved that the change of the acceleration in the vertical direction (direction Y) is larger than those of other directions during the human 300 walks. Additionally, it has been proved that the change of the acceleration in a direction in the range of an inclined angle of 45 degrees from the vertical direction tends to be larger than those of directions out of the range of the inclined angle of 45 degrees from the vertical direction.

From the above results, the movable portion 2a can be conceivably effectively vibrated by arranging the power generator 2 such that the movable portion 2a vibrates in the vertical direction during the human 300 walks. Therefore, according to the first embodiment, as hereinabove described, the power generation efficiency during the user walks can be improved by arranging the movable portion 2a such that the vibration direction of the movable portion 2a is in the range of the inclined angle of 45 degrees from the vertical direction in the used state of the electronic apparatus 1, dissimilarly to the case where the movable portion 2a is arranged such that the vibration direction of the movable portion 2a is arranged out of the range of the inclined angle of 45 degrees from the vertical direction.

### Second Embodiment

An electrostatic induction power generator 20 is employed as a power generator of an electronic apparatus 1 according to a second embodiment dissimilarly to the electromagnetic induction power generator 10 employed in the electronic apparatus according to the aforementioned first embodiment.

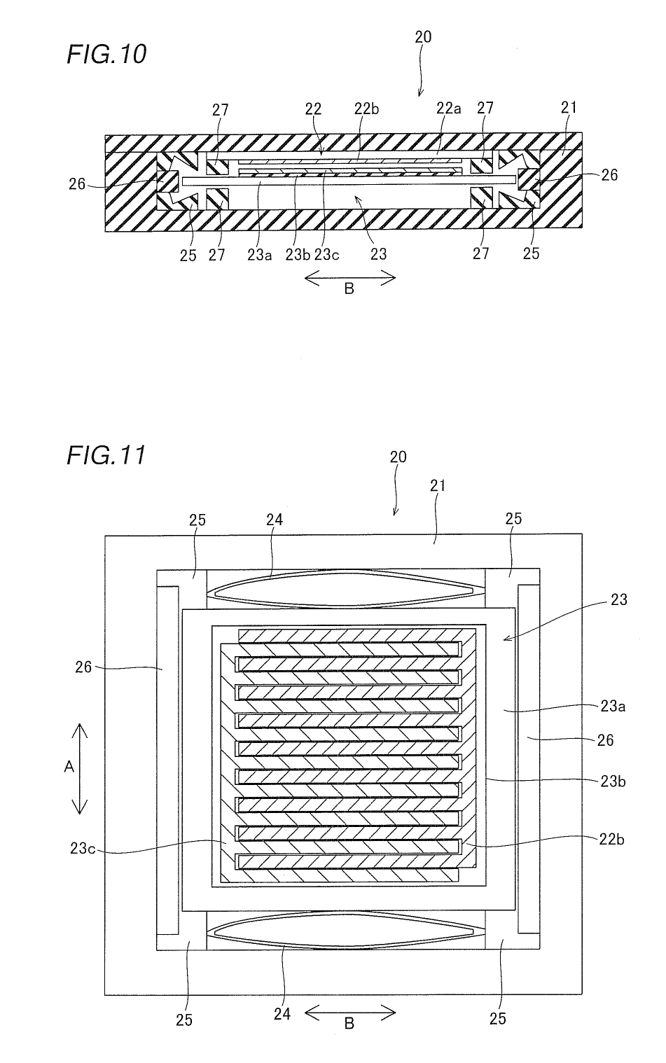

As shown in FIGS. 10 and 11, the power generator 20 comprises a boxlike housing 21, a fixed electrode portion 22 (see FIG. 10) fixed on an inner surface of the housing 21, a movable electrode portion 23 movable linearly, springs 24 (see FIG. 11) for vibrating movable electrode portion 23 along arrow A, guides 25 and spacers 26 for regulating a lateral position (along arrow B) of the movable electrode portion 23 and spacers 27 (see FIG. 10) for regulating a longitudinal position of the movable electrode portion 23. The movable electrode portion 23 is an example of the “movable portion” in the present invention. The fixed electrode portion 22 includes a substrate 22a and an interdigitally formed collector 22b. The fixed electrode portion 22 is an example of the “fixed portion” in the present invention. The movable electrode portion 23 includes a substrate 23a, an electret film 23b formed on a surface of the substrate 23a, a guard electrode 23c interdigitally formed on a surface of the electret film 23b. In the power generator 20, the movable electrode portion 23 including the electret film 23b vibrates in the housing 21, so that the quantity of charges induced in the collector 22b by electrostatic induction can be changed. Thus, a current can be generated in a circuit (not shown) connected to the guard electrode 23c and the collector 22b. In the power generator 20, the movable electrode portion 23 vibrates following displacement of the electronic apparatus 1 (see FIG. 1), and hence power is generated following the displacement of the electronic apparatus 1. The fixed electrode portion 22 and the movable electrode portion 23 are each an example of the “conversion portion” in the present invention.

The effects of the second embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

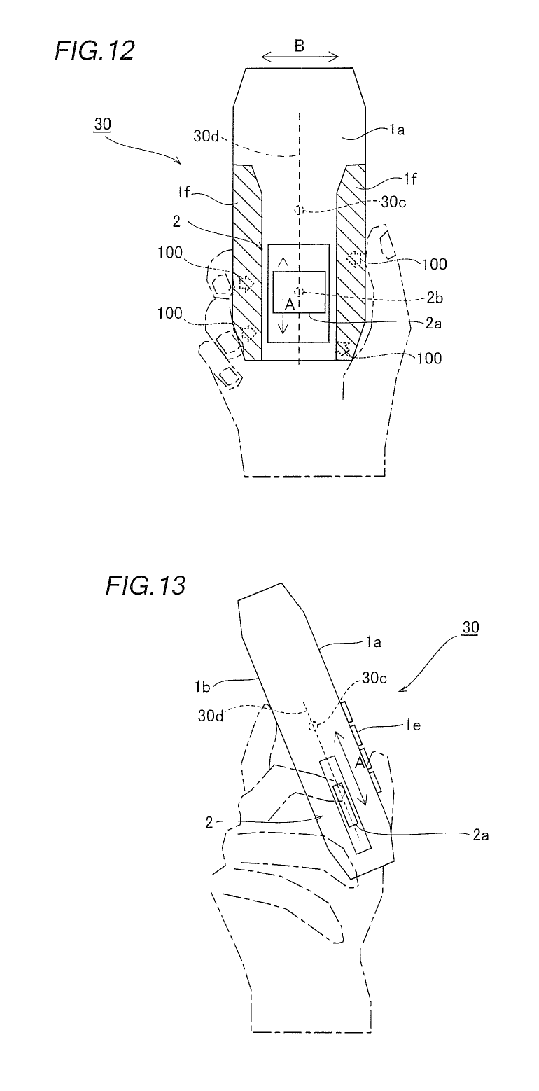

For example, while the movable portion 2a is arranged on the side of the rear surface portion 1b in the aforementioned first embodiment, the present invention is not restricted to this but a movable portion 2a may be so arranged that the movable portion 2a vibrates on a centerline 30d passing a gravity center 30c of an electronic apparatus 30 as in the electronic apparatus 30 according to a first modification of the first embodiment shown in FIGS. 12 and 13. Thus, inertial force by vibration of the movable portion 2a can apply on the centerline 30d passing a gravity center 30c of an electronic apparatus 30 and hence the inertial force by vibration of the movable portion 2a can inhibit the electronic apparatus 30 from rotating about the gravity center 30c. Consequently, the power generator 2 can generate power while further suppressing destabilization of the attitude of the electronic apparatus 30. It is to be noted that the vibration center 2b (see FIG. 12) of the movable portion 2a is not necessarily located on the centerline 30d so far as the movable portion 2a is so arranged as to vibrate on the centerline 30d even when the vibration center 2b of the movable portion 2a is not located on the centerline 30d.

While the electromagnetic induction power generator 10 and the electrostatic induction power generator 20 are shown as specific examples of the power generator 2 in the aforementioned first and second embodiments, the present invention is not restricted to this but another power generation portion such as a capacitance power generation portion or a piezoelectric power generation portion may be alternatively employed.

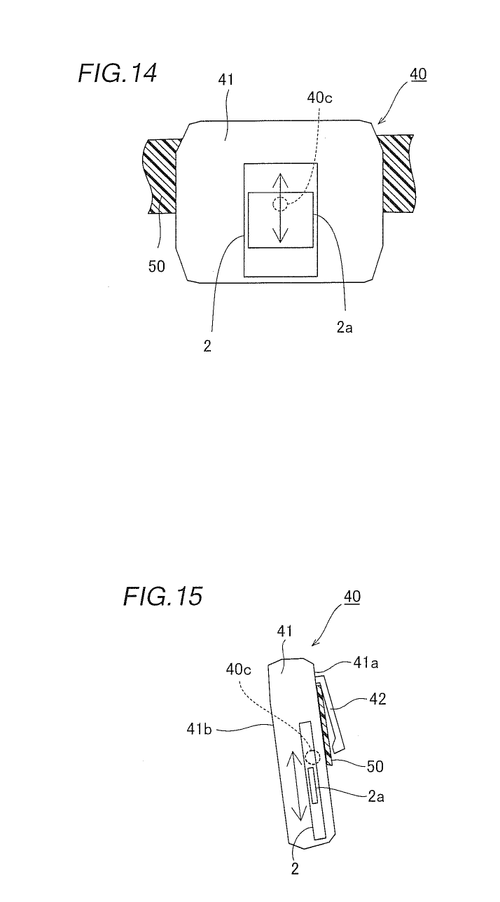

While the aforementioned first embodiment of the present invention is applied to the electronic apparatus 1 used while being grasped and supported by the hand of the user, such as a portable telephone or a remote control, the present invention is not restricted to this but is also applicable to another electronic apparatus worn on a body or clothing of the user such as a pedometer or a pager as in an electronic apparatus 40 according to a second modification of the first embodiment shown in FIGS. 14 and 15.

This electronic apparatus 40 includes a body 41, a power generator 2 including a movable portion 2a arranged below a gravity center 40c of the body 41 in the body 41 and a clip 42 (see FIG. 15) provided on a side of a rear surface portion 41a of the body 41. A front surface portion 41b of the body 41 is provided with an operating portion such as buttons (not shown). The electronic apparatus 40 is worn on a belt 50 of the user by hooking the clip 42 on the belt 50. Also in such an electronic apparatus 40 worn on the body or the clothing of the user, the movable portion 2a is arranged below the gravity center 40c of the electronic apparatus 40, whereby the power generator 2 can generate power while suppressing destabilization of the attitude of the electronic apparatus 40. Also in a case where the arrangement of the movable portion 2a in the electronic apparatus 1 and the structure of the vibration direction of the movable portion 2a or the like are applied to the electronic apparatus 40, effects similar to those of the electronic apparatus 1 can be obtained.

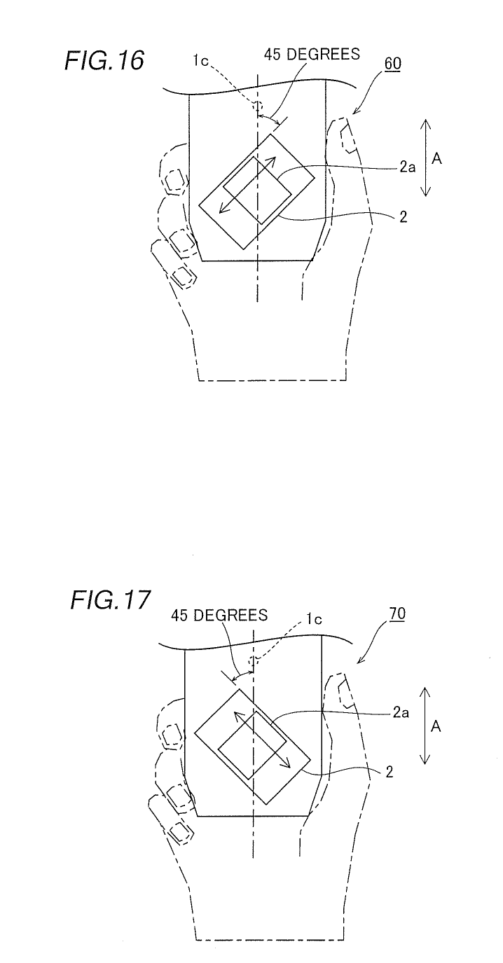

While the movable portion 2a is so arranged that the vibration direction of the movable portion 2a is the direction (along arrow A) along the surface of the rear surface portion 1b of the electronic apparatus 1 in the used state of the electronic apparatus 1 in the aforementioned first embodiment, the present invention is not restricted to this but the movable portion 2a may be so arranged that the vibration direction of the movable portion 2a is in the rage of an inclined angle of 45 degrees from the direction (along arrow A) along the surface of the rear surface portion 1b of the electronic apparatus 1 as in electronic apparatuses 60 and 70 according to third and fourth modifications of the first embodiment shown in FIGS. 16 and 17 respectively.

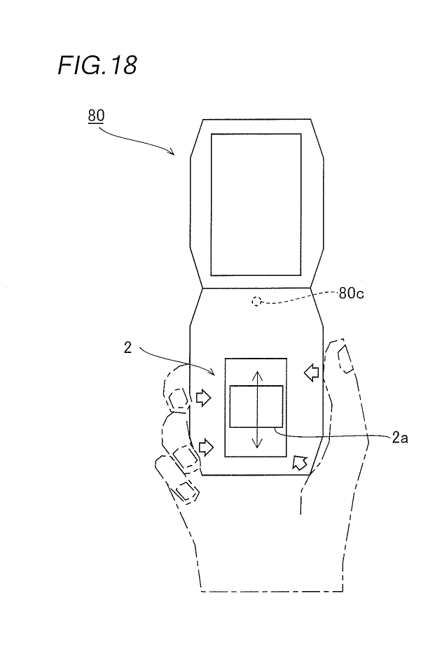

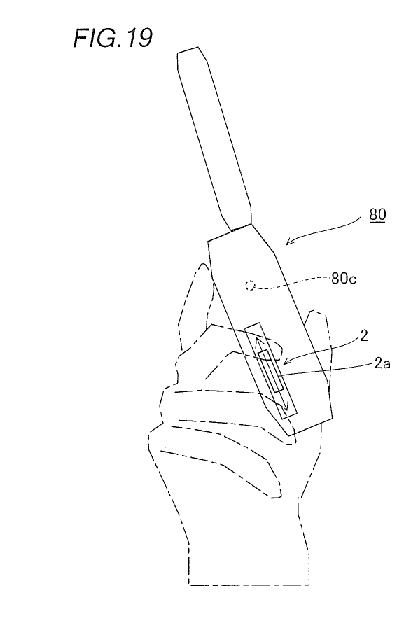

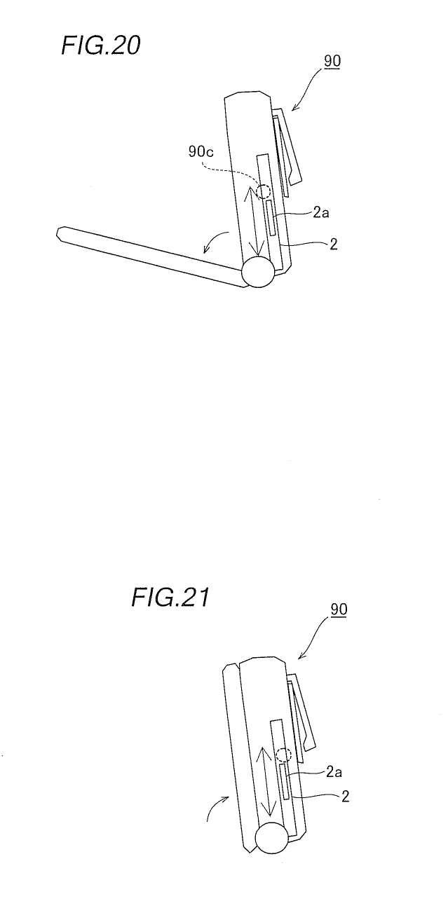

While the power generator 2 is arranged below the gravity center 1c of the electronic apparatus 1 in the aforementioned first embodiment, a fold-up electronic apparatus 80 according to a fifth modification shown in FIGS. 18 and 19 is so formed that a shape thereof is changeable between a first state where the fold-up electronic apparatus 80 is used (before folding) and a second state where the fold-up electronic apparatus 80 is not used (after folding). In a case where positions of the gravity center before and after folding are different, it is only necessary to determine the position of the movable portion 2a of the power generator 2 by a gravity center position 80c in the used state of the electronic apparatus 80, namely a state of before folding the electronic apparatus 80. Similarly, in a case where positions of the gravity center before and after folding are different as in an electronic apparatus 90, such as a pedometer, according to a sixth modification of the first embodiment shown in FIGS. 20 and 21, it is only necessary to determine the position of the movable portion 2a of the power generator 2 by a gravity center position 90c in the used state of the electronic apparatus 90, namely a state of after folding the electronic apparatus 80. Similarly, also in a case of a slide electronic apparatus, it is only necessary to determine the position of a power generator by a gravity center position in a used state.

While the movable portion 2a is arranged below the gravity center 1c in the aforementioned first and second embodiments, the present invention is not restricted to this but the movable portion 2a may be arranged on the position of the gravity center 1c. In this case, the position of the vibration center 2b of the movable portion 2a and the gravity center 1c may alternatively be matched with each other.

While the power generator 2 including the movable portion 2a linearly vibrating is employed in the aforementioned first and second embodiments, the present invention is not restricted to this but a power generator including a movable portion rotatably moving may alternatively be employed.

While the power generator 2 is arranged in the electronic apparatus 1 in the aforementioned first and second embodiments, the present invention is not restricted to this but a part or all of the power generator 2 may alternatively be arranged integrally with the electronic apparatus 1 or be detachably attached to the outside of the electronic apparatus 1.

While the nonslip structures 1f having prescribed shaped dents are provided on the surfaces of the electronic apparatus 1 in the aforementioned first and second embodiments, the present invention is not restricted to this but a material having a high friction coefficient such as rubber may alternatively be mounted on the surfaces of the electronic apparatus.

While the power generator 2 is so arranged that the vibration direction of the movable portion 2a is the direction (along arrow A) along the surface of the rear surface portion 1b of the electronic apparatus 1 in the aforementioned first and second embodiments, the present invention is not restricted to this but the vibration direction of the movable portion may alternatively be a horizontal direction.

What is claimed is:

1. An electronic apparatus comprising:
a power generator including a movable portion displaced by kinetic energy acting on an electronic apparatus body and a conversion portion converting displacement of said movable portion to electric energy, wherein
said movable portion of said power generator is arranged on or below a gravity center of said electronic apparatus body in a state where said electronic apparatus body is supported in a used state.

2. The electronic apparatus according to claim 1, wherein
said power generator supplies electric power to at least one electronic component in said electronic apparatus body.

3. The electronic apparatus according to claim 1, wherein
said electronic apparatus body includes a front surface portion having an operating portion and a rear surface portion, and
said movable portion is arranged on a side of said rear surface portion of said electronic apparatus body.

4. The electronic apparatus according to claim 1, wherein
said movable portion is arranged at a position in said electronic apparatus body, corresponding to a portion grasped by a hand of a human in the used state.

5. The electronic apparatus according to claim 1, wherein
said electronic apparatus body is provided with a gripper having a nonslip structure, and
said movable portion is arranged at a position corresponding to a region provided with said nonslip structure.

6. The electronic apparatus according to claim 1, wherein
said movable portion is arranged below said gravity center of said electronic apparatus body in the state where said electronic apparatus body is supported in the used state.

7. The electronic apparatus according to claim 1, wherein
said movable portion is arranged on a lower portion of said electronic apparatus body in the state where said electronic apparatus body is supported in the used state.

8. The electronic apparatus according to claim 1, wherein
said electronic apparatus body is used in a state of being supported by a user or being mounted, and
said movable portion is so formed as to generate power by displacement due to kinetic energy acting on said electronic apparatus body resulting from movement of the user.

9. The electronic apparatus according to claim 1, wherein
said electronic apparatus body includes a front surface portion and a rear surface portion, and
said movable portion is so formed as to move in a direction along a surface of said front surface portion or said rear surface portion of said electronic apparatus body.

10. The electronic apparatus according to claim 1, wherein
said movable portion is so formed as to linearly vibrate, and
said movable portion is so arranged as to vibrate on a line passing said gravity center of said electronic apparatus body.

11. The electronic apparatus according to claim 10, wherein
said electronic apparatus body includes a front surface portion and a rear surface portion, and
said movable portion is so arranged as to vibrate on a line extending in a vertical direction passing said gravity center of said electronic apparatus body as viewed from a side of said front surface portion, in a direction along a surface of said front surface portion or said rear surface portion of said electronic apparatus body.

12. The electronic apparatus according to claim 1, wherein
said movable portion is so formed as to linearly vibrate, and
a motion direction of said movable portion is in the range of an inclined angle of 45 degrees from a vertical direction in the state where said electronic apparatus body is supported in the used state.

13. The electronic apparatus according to claim 12, wherein
said movable portion is so formed as to vibrate in a substantially vertical direction in the state where said electronic apparatus body is supported in the used state.

14. The electronic apparatus according to claim 1, wherein
said movable portion is so arranged as to vibrate on a centerline extending in a vertical direction of said electronic apparatus body in the state where said electronic apparatus body is supported in the used state.

15. The electronic apparatus according to claim 1, wherein
said electronic apparatus body is so formed that a shape thereof is changeable between a first state where said electronic apparatus is used and a second state where said electronic apparatus is not used, and
said movable portion is arranged on or below said gravity center of said electronic apparatus body in a state where said electronic apparatus body is supported in said first state.

16. The electronic apparatus according to claim 1, wherein
said electronic apparatus body includes any of a portable telephone, a remote control, a pedometer and a pager.

17. The electronic apparatus according to claim 1, further comprising a fixed portion corresponding to and relatively movable to said movable portion, wherein
said conversion portion is so formed as to convert the kinetic energy acting on said electronic apparatus body to electric energy by relative movement of said movable portion to said fixed portion.

18. The electronic apparatus according to claim 17, wherein
either one of said movable portion or said fixed portion includes a permanent magnet,
either the other of said movable portion or said fixed portion includes a coil, and
said power generator is so formed as to allow power generation by electromagnetic induction resulting from relative movement of said permanent magnet and said coil.

19. The electronic apparatus according to claim 17, wherein
either one of said movable portion or said fixed portion includes an electret film,
either the other of said movable portion or said fixed portion includes a collector, and
said power generator is so formed as to allow power generation by electrostatic induction resulting from relative movement of said electret film and said collector.
